(19) United States
(12) Patent Application Publication
(10) Pub. No.: US 2020/0215360 A1
(43) Pub. Date: Jul. 9, 2020

(54) RESPIRATORY EQUIPMENT FOR AIRCRAFT PILOT WITH NO FACE CONTACT

(71) Applicant: Zodiac Aerotechnics, Plaisir (FR)

(72) Inventors: Jean-Baptiste Delprat, Chaville (FR); Olivier Potet, La Villedu Bois (FR); Romain Fenerie, Saint Cyr I'Ecole (FR)

(21) Appl. No.: 16/624,203

(22) PCT Filed: Jul. 5, 2018
(86) PCT No.: PCT/IB2018/001606

§ 371 Date: Dec. 18, 2019

Related U.S. Application Data
(60) Provisional application No. 62/528,760, filed on Jul. 5, 2017.
(60) Provisional application No. 62/661,385, filed on Apr. 23, 2018.

(30) Foreign Application Priority Data
Jun. 6, 2018 (FR) 1854906

(51) Int. Cl. A62B 18/04; A62B 7/14; A62B 18/08; A62B 9/00; B64D 11/00

(52) U.S. Cl. CPC A62B 18/04; A62B 7/14; B64D 11/00; A62B 9/00; A62B 18/08

(57) ABSTRACT

A respiratory equipment for an aircraft, with a pilot forming a user, comprising a shoulder support, a base frame with a deformable membrane which comprises a adaptive size central orifice, configured to selectively surround in a substantially airtight manner the neck of the user, a rigid visor movably mounted on the base frame, between a retracted position and a use position wherein the rigid visor contacts in an airtight manner the base frame, an extendible canopy with arches and a flexible wall, coupled in an airtight manner to an upper border of the rigid visor, whereby when the rigid visor is in the closed/use position and the deformable membrane surrounds in substantially airtight manner the neck of the user, a substantially closed volume is provided, delimited by the deformable membrane, the base frame, the extendible canopy and the rigid visor, with a gaseous exchange only possible through one or two gas conduits.

### FIELD OF THE INVENTION

The present disclosure relates to respiratory equipment for aircraft pilots.

### BACKGROUND OF THE DISCLOSURE

There is a trend to push and/or oblige pilots and/or first officers of aircrafts to wear a respiratory equipment in a preventive mode, such respiratory equipment being intended to avoid hypoxia phenomenon in case of decompression at certain cruising altitudes.

More precisely, a preventive wear of a respiratory equipment is required for cruising altitudes above 41 kfeet and/or if only one pilot is present in the flight deck for cruising altitudes above 25 kfeet. This preventive wear may be also required for some flight domain conditions and/or some geographical areas (e.g. high mountains area).

Under this perspective, there is a need to propose new solutions to favor the practicality and comfort of respiratory equipment.

### SUMMARY OF THE DISCLOSURE

According to one aspect of the present invention, there is disclosed a respiratory equipment for an aircraft, a pilot or first officer of the aircraft forming a user of the respiratory equipment, the respiratory equipment comprising:
a shoulder support,
a base frame with a deformable membrane which comprises a central orifice with a adaptive size, configured to selectively surround in a substantially airtight manner the neck of the user, the base frame being mounted on the shoulder support,
a rigid visor movably mounted on the base frame, between a retracted position and a use position wherein the rigid visor contacts in an airtight manner the base frame,
an extendible canopy with one or more arch(es) and a flexible wall, coupled in an airtight manner to an upper border of the rigid visor,
   whereby when the rigid visor is in the use position and the deformable membrane surrounds in substantially airtight manner the neck of the user, a substantially closed volume is provided, the closed volume being delimited by the deformable membrane, the base frame, the extendible canopy and the rigid visor.

Thanks to these dispositions, the head of the pilot has no contact with the rigid visor, no element is worn on the face, which turns out to be very comfortable for the pilot and/or first officer which in turn increase safety and availability for them to perform other critical tasks.

Advantageously, since the proposed solution avoids any contact between the user face and the respiratory equipment, the proposed solution is perfectly compatible with any type of beard and/or moustaches, including also large earrings.

Advantageously, the proposed solution allows the user to lower the rigid visor quickly and conveniently to reach and secure the use position and the effective usage of the respiratory equipment.

The closed volume is insulated from exterior environment and a respirable air is provided therein, possibly with a gaseous exchange perform through one or two gas conduits coupled to an air generating/rebreathing system.

The term “rigid visor” means here a self-supporting transparent wall. Human vision is not substantially impaired or hindered through this rigid visor.

The term “deformable membrane” means a flexible layer of material, which is, unless stated otherwise, continuous and does not let air pass through. Flexibility and extensibility of such membrane are substantial.

The term “use position” for the rigid visor means the rigid visor is closed against the base frame. In this configuration, the respiratory equipment is actually used by the user to breathe respirable air.

In various embodiments of the invention, one may possibly have recourse in addition to one and/or other of the following arrangements, taken alone or in combination.

According to one option, there is provided an aperture control device to change the central orifice of the deformable membrane from a large aperture state to a small aperture state in which the deformable membrane surrounds in a substantially airtight manner the neck of the user. Whereby, in the event of sudden requirement to use of respiratory equipment, the central orifice of the deformable membrane can be reduced quickly to be applied around the neck of the user. Conversely when effective use of respiratory equipment is not required, the deformable membrane can be moved away from the neck of the user which provides comfort from the user/pilot standpoint. The large aperture state also allows the user head pass through. According to one option, there is defined a surfacic ratio L/S defined by the area of the large aperture state divided by the area of the small aperture state, where L/S is at least 4, preferably at least 5, and preferably about 6.

According to one option, the aperture control device is driven in dependence with the movement of the rigid visor. Whereby the pilot has just to move down the rigid visor, this automatically triggers a reduction of the central orifice of the deformable membrane. The pilot/user is not required to bother about the deformable membrane adjustment around his/her neck since the lowering of the rigid visor will change the central orifice from a large aperture to a small aperture without additional control from the pilot.

According to one option, the aperture control device is driven by a cable link driven by the rigid visor. This is a simple and reliable solution, this improves safety.

According to one option, the aperture control device comprises a manual adjustment complementary device. Advantageously, after the automatic reduction of size of the central orifice, the pilot/user may adjust the tightening force on his/her neck to fit personalized need.

According to one option, the aperture control device comprises a stationary ring a movable ring and extensible cords, wherein the deformable membrane is formed as a sleeve, wherein a first border and a second border of the deformable membrane being attached to the stationary ring wherein, for each cord, a first end is attached to the stationary ring and a second end is attached to the movable ring. Thereby, under rotation of the movable ring, the cords extend and pull the deformable membrane inwardly along a radial direction.

According to one option, the extensible cords are resilient and provide an elastic return to the large aperture state, and the movable ring comprises a control lever, actuable manually and/or by the cable link.

According to one option, the movable ring is elastically returned by an elastic member. This is a complementary means, additional to resilience of the cords themselves.

According to one option, the deformable membrane comprises an elastomeric polymer, with a large elastic extension coefficient. Linear extension coefficient can be as large as 2, even 2.5. Ratio or large aperture versus small aperture can be at least 4 in terms of area of the central orifice.

According to one option, there may be provided additionally a fabric collar configurable to come into contact with the neck of the user; thus enhancing comfort. This fabric collar can be replaced, thus improving hygienic conditions.

According to one option, the fabric collar can be detachably coupled to a radial middle portion of the deformable membrane.

According to one option, the central orifice of the membrane is, in a large aperture state, large enough to let an adult human head pass therethrough, in practice a opened cross section at least 300 cm², preferably an opened cross section of at least 400 cm², and more preferably an opened cross section of at least 500 cm². This allows the pilot/user to easily put on the helmet-like respiratory equipment and furthermore without damaging his/her hairstyle. The central orifice may exhibit a substantially circular or elliptic shape.

According to one option, the respiratory equipment may further comprise a locking system for holding the rigid visor in at least one position, and a unlocking actuator/pushbutton, wherein the locking system provides locking of the rigid visor both in the retracted position (P2) and in the use position (P1). Advantageously, the retracted position is secured and thus the rigid visor cannot go down inadvertently, even though the plane undergoes shaking. The use position is also secured, and the close volume for breathing has no risk to be broken by an unintentional raise of the rigid visor, even though the plane undergoes shaking

According to one option, the upper border of the rigid visor is arcuate on both side area (left & right) providing a good side visibility. A wide pilot vision is not substantially impaired through this rigid visor even when looking at the sides.

According to one option, the arches of the extendible canopy are arranged so they are encompassed in one another when the extendible canopy is fully retracted. Said otherwise, the arches, when retracted, are piled up like Russian dolls. The arches, when canopy is deployed, also give advantageously structure to the canopy so contact is avoided with the top of the user's head.

According to one option, the arches of the extendible canopy have substantially the same shape as the upper border of the rigid visor. Advantageously in the retracted position, the upper border of the rigid visor and the arches occupy a small space. There is room left with regard to the seat headrest, which provides comfort from the user/pilot standpoint.

According to one option, the rigid visor is rotatably mounted on the base frame with an articulation axis Y arranged at a lower auricular area with regard to the user's head position. Simple and reliable kinematics.

According to one option, there are provided one or more injectors for providing fresh air with oxygen in the closed volume, said injectors are arranged in the front area of the base frame. Fresh air is dispensed at the right place.

According to one option, the respiratory equipment may further comprise a rebreathing system coupled to the closed volume through one or more gas conduits. Overall oxygen consumption is thus reduced.

According to one option, the extendible canopy comprises a rear wall and a flexible top wall arranged on the arches.

According to one option, the rear wall of the canopy is coupled in a substantially airtight manner to the base frame.

According to one option, the respiratory equipment may further comprise a microphone and one or two loudspeakers. Thereby, the pilot/user can perform audio communication, with local devices, without need to listen to the deck loudspeakers or to speak to a cabin microphone.

According to one option, the respiratory equipment may further comprise a position sensor configured to detect the rigid visor is in the use position, and therefore the avionics system automatically switches audio channel to the microphone and loudspeakers provided in the respiratory equipment.

### BRIEF DESCRIPTION OF THE DRAWINGS

Other features and advantages of the invention appear from the following detailed description of one of its embodiments, given by way of non-limiting examples, and with reference to the accompanying drawings, in which:

FIG. 1 shows a diagrammatic perspective view of a respiratory equipment according to the present disclosure, with the rigid visor in use position, a closed volume encompassing the pilot's head thereby enabling respiration, and allowing wide visibility,

FIG. 2 is analogous to FIG. 1 and shows the respiratory equipment, with the rigid visor in a retracted position, the flight deck ambient air is used for breathing,

FIGS. 3A, 3B and 3C show the deployment of the extendible canopy and rigid visor from a retracted position to a use position,

FIG. 4 shows a top view of the base frame, with a deformable membrane in a large aperture configuration, corresponding to the retracted position of the rigid visor,

FIG. 5 shows a cross sectional view of the base frame assembly, taken along line V-V in FIG. 4,

FIG. 6 is analogous to FIG. 4 and shows the deformable membrane during shift to a smaller aperture configuration,

FIG. 7 is analogous to FIG. 4 and shows the deformable membrane in the use position, wherein it surrounds in a substantially airtight manner the neck of the pilot, small aperture configuration,

FIGS. 8A and 8B shows a linkage system to drive the membrane aperture control system upon closing movement of the rigid visor,

FIG. 9 shows a locking mechanism to secure the rigid visor either in retracted position or in use position.

FIG. 10 shows a rebreathing system,

FIG. 11 shows a cross sectional view of the base member and deformable membrane surrounding the neck of the user.

### DETAILED DESCRIPTION OF THE DISCLOSURE

In the figures, the same references denote identical or similar elements. It should be noted that, for clarity purposes, some element(s) may not be represented at scale.

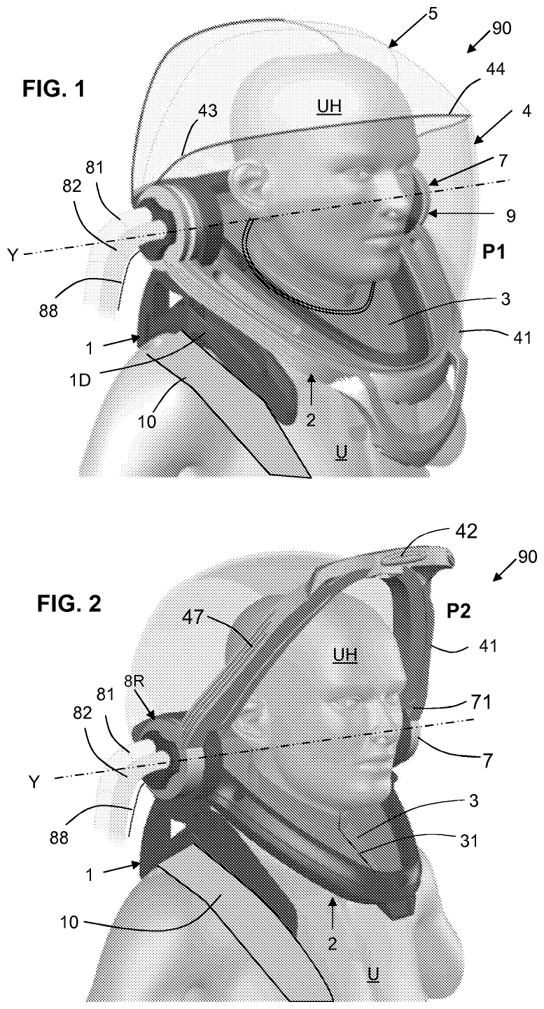

As shown in FIG. 1, an aircraft pilot denoted U wears a respiratory equipment 90. Instead of a pilot, the user of the respiratory equipment 90 can be a first officer of the aircraft.

The user U of the respiratory equipment can be a male individual or a female individual; anthropometrics can vary from one subject to another, notably size of head, height of the neck, and generally all anthropology metrics.

Also hairstyle can vary from one subject to another; some people have short hair, some people have long hair. The number of female pilots/copilots is increasing and the proposed respiratory equipment shall be compatible with a large range of anthropometric metrics. Advantageously the solution is also compatible with various horsetail/ponytail hairstyles.

Also some male pilots like to wear beard or moustache. Again here many beard styles are considered, as far as hair length or areas covered. The proposed respiratory equipment shall be compatible with most popular beard styles. Advantageously, since the proposed solution avoids any contact between the user face and the respiratory equipment, the proposed solution is perfectly compatible with any type of beard or moustaches, including also large earrings.

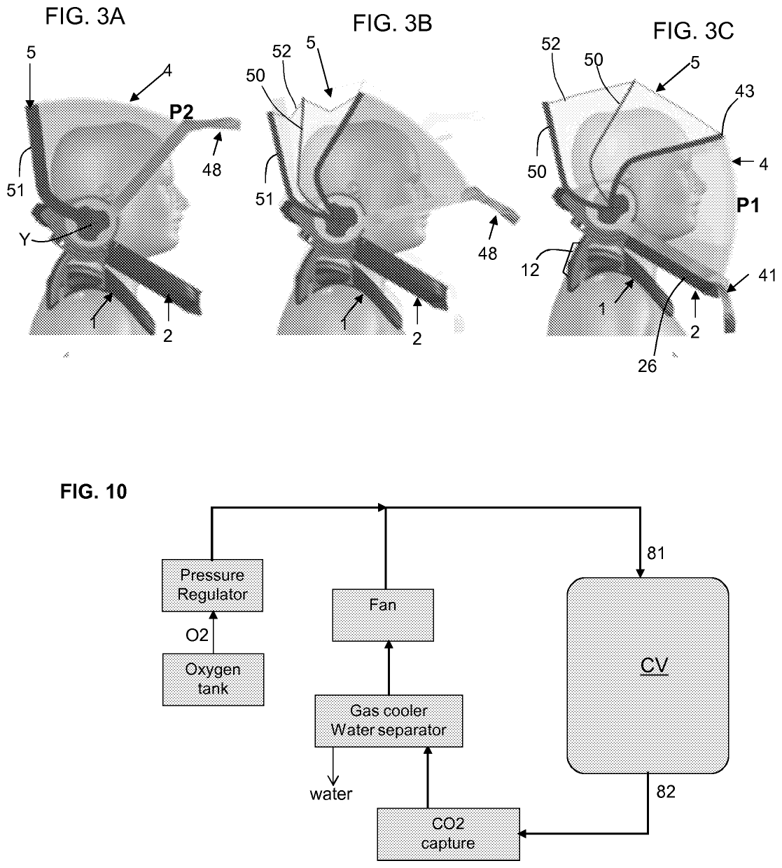

In the respiratory equipment, there is provided a shoulder support 1. The shoulder support comprises a left member 1G and right member 1D; there can be provided a linking member 12 to link the left and right support members, said linking member 12 may be arranged at the back area as shown at FIG. 3C. We note here that the linking function can be provided by the base frame that will be discussed later.

As apparent from FIGS. 1 to 2, the shoulder support is compatible with a variety of pilot safety harness 10. In one embodiment, the pilot safety harness 10 can be secured atop a portion of the left and right shoulder support members. In another embodiment, the pilot may have installed beforehand his/her safety harness 10 and install subsequently the respiratory equipment such that left and right shoulder support members locate atop the pilot safety harness 10.

The shoulder support 1 may be adjustable in size: span between the left and right support members can be adapted for example by increments.

The shoulder support may comprise comfort pads in the concave area oriented downward, intended to be in contact with the top of the user's shoulder where weight of the respiratory equipment is mainly transmitted to the user.

The shoulder support 1 may be made of hard synthetic material a reinforced plastic or the like.

Base Frame

There is provided a base frame 2 mounted on the shoulder support 1. In the illustrated example, the base frame is fixedly secured to the shoulder supports, from another perspective the shoulder supports are fixedly secured to the base frame. According to another possible option, there may be provided a height adjustment system to take into account neck human variety; for example the height of base frame with regard to shoulder supports might be adapted, for example by increments, via a latch system of a rotary-controlled rack&pinion.

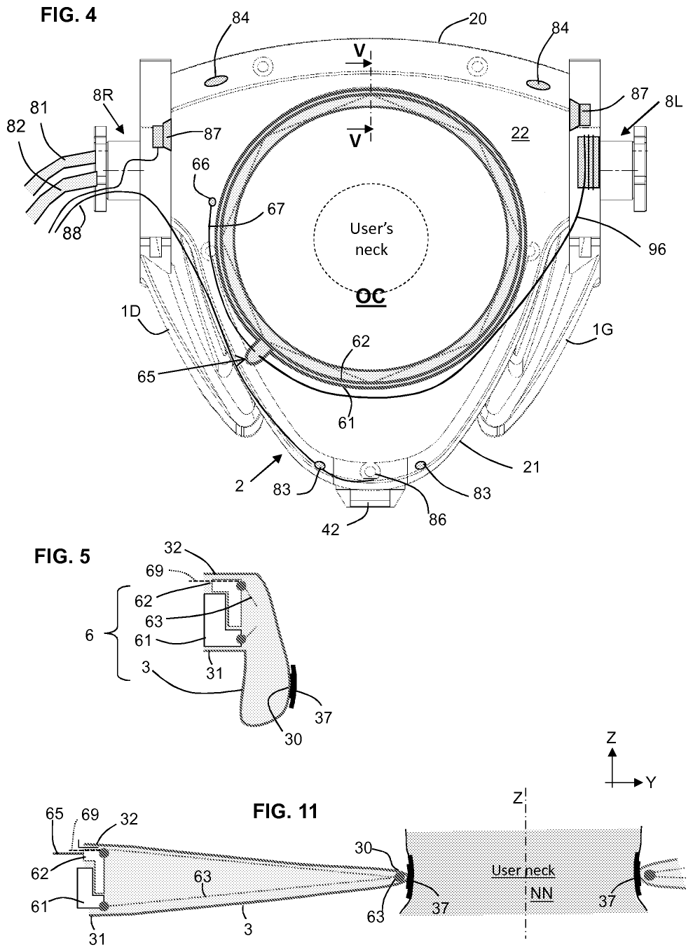

The base frame comprises an arcuate front portion 21 forming an armature/strength member and a back portion 20, fixed to one another. The back portion can be straight or can have a slightly arcuate shape with the concave said oriented toward the neck axis area, e.g. towards the arcuate front portion 21 (FIG. 4).

The base frame 2 defines a central passage large enough for the user to pass his/her head through. The structure and features encompassed within the base frame will be detailed later.

The base frame 2 may be made of hard synthetic material a reinforced plastic or the like, PET, PP, etc. . . . There may be provided a metallic armature therein.

Rigid Visor

There is provided a rigid visor 4 movably mounted on the base frame 2, between a retracted position (P2, FIGS. 2 and 3A) and a use position (P1, FIGS. 1 and 3C). In the use position P1, the rigid visor 4 contacts in an airtight manner the base frame 2.

In the illustrated example, the rigid visor 4 is rotatably mounted on the base frame, with a hinge having an axis denoted Y. There is provided an articulation unit 8L at the left side and an articulation unit 8R at the right side, both can have extra function beyond rotative mount as will be seen later.

In the illustrated example, the rigid visor 4 is made of transparent material like polycarbonate or the like. The rigid visor 4 has an overall arcuate shape. The lower border 47 of the rigid visor has a similar shape as the arcuate front portion 21 of the base frame. There may be provided a seal (not shown) to tightly join the lower border of the base frame to the arcuate front portion 21 of the base frame.

The upper border 44 extends front the hinge axis Y upwardly, and there is provided a curve 43 oriented downwards. In this configuration, the pilot/user U has direct view on the environment both forwards and on the sides; good visibility is thus ensured even when the rigid visor 4 is lowered.

There is provided a locking system assembly 7, which will be described later.

Canopy

There is provided an extendible canopy 5 with one or more arches 50 and a flexible wall, coupled in an airtight manner to an upper border of the rigid visor 4.

The extendible canopy 5 comprises a rear wall 51 and a flexible top wall 52 arranged on the arches 50. The top wall of the extendible canopy 5 can be made of a coated fabric or can be made from a flexible polymer material. The rear wall can be made of the same material. According to one option, the material of the rear wall and canopy are integrally formed which is beneficial for air tightness. The canopy material may be translucent or even transparent.

The arches 50 of the extendible canopy are arranged so they are encompassed in one another when the extendible canopy is fully retracted (FIG. 3A). More precisely, the arches, when retracted, are piled up like Russian dolls. The arches, when canopy is deployed, also give advantageously structure to the canopy so contact is avoided with the top of the user's head (FIG. 3C). In this configuration, the flexible top wall is tensed. The flexible top is not loose and there is enough room to accommodate many hairstyles without hair touching the canopy. It is therefore very comfortable for the use compared to known hoods.

There is room left for ponytail hairstyle at the rear wall 51.

Advantageously in the retracted position, the upper border of the rigid visor and the arches occupy a small space. Behind the rear wall 51, there is room left with regard to the seat headrest, which provides comfort from the user/pilot standpoint. Therefore there is provided freedom for shoulder movement or shoulder slight rotation without hindrance from the back of the respiratory equipment (shoulder support and canopy rear wall).

There may be provided 2 or 3 arches. Each arch may be made as a flexible rod having a cross-section round or rectangle, for example between 3 mm² and 5 mm². Each arch may be made of flexible reinforced plastic material.

The perimeter of the rear wall 51 can be view as the rearmost arch.

According to another possibility, all the arches 50 of the extendible canopy may have substantially the same shape as the upper border of the rigid visor.

When the rigid visor 4 is in the closed/use position, there is defined an interior volume which is delimited by the base frame, the extendible canopy and the rigid visor. The respiratory equipment can be viewed as a wide hood or a head contact-free helmet.

The respiratory equipment can exhibit the weight comprised between 1 kg and 3 kg. This weight is advantageously supported by the shoulders of the user U, no weight is supported by the head itself.

The respiratory equipment 90 may comprise two gas conduits 81,82 for providing respirable air to the user, a rebreathing system is described later in relation to FIG. 10.

There may be a single gas conduit instead of two in one configuration not shown.

The respiratory equipment 90 may further comprise a microphone 86 and one or two loudspeakers 87 for enabling audio communication between the user and other people (in the aircraft or remotely located). In the shown example, the microphone 86 is located in front of the mouth of the pilot/user U in use configuration (FIG. 4), there are two loudspeakers 87 are located behind the visor hinge axis.

Further, there is provided an electric cable 88, for linking/coupling the microphone and loudspeakers with the onboard audio equipment and remote communications.

In the illustrated example, the gas conduits 81,82 and the electrical cable 88 enter the interior volume through the right side articulation 8R.

As apparent from FIGS. 3A to 3C, a movement of the rigid visor drives a movement of the extendible canopy. More precisely, FIG. 3A shows the fully retracted position P2 where the flexible canopy is collapsed on itself with the arches next to one another or the arches encompassed one another (Russian dolls). In this configuration, the pilot has direct view on the environment both forwards and on the sides. When the user U pulls the rigid visor downwards by grasping the handle 48 (with optional prior unlocking as discussed later), the upper border 43 of the visor pulls accordingly the forwardmost arch 50, and the other arches when the movement is carried on. (FIG. 3B shows an intermediate state).

The visor rotates around axis Y. the arches 50 also rotate around axis Y. The rear wall 51 of the extendible canopy remains stationary.

When the rigid visor reaches the lower most position, i.e. in contact with the base frame arcuate portion 21, the flexible wall 52 of the canopy is substantially tensed as illustrated at FIG. 3C. At this point, an interior volume of the respiratory equipment which is delimited by the base frame, the extendible canopy and the rigid visor.

Conversely, when the user wants to release the equipment, the user pushes up the rigid visor and the reverse operation takes place with rotation of the visor and collapsing of the extendible canopy.

It is important to note is that the head UH of the user has no contact with the rigid visor, and no element is worn on the face, this is true both in the retracted position P2 and in the use position P1. Thereby the comfort of use is increased.

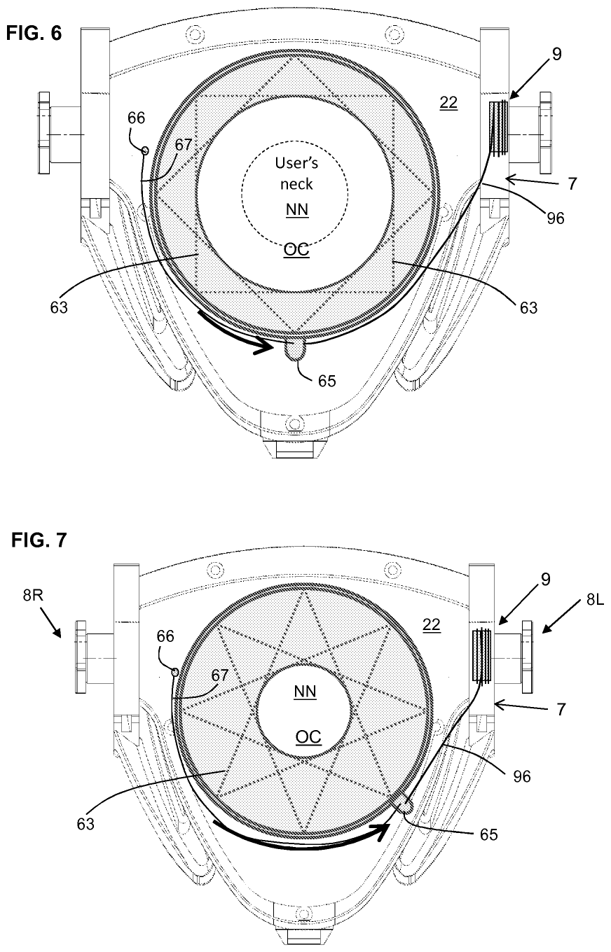

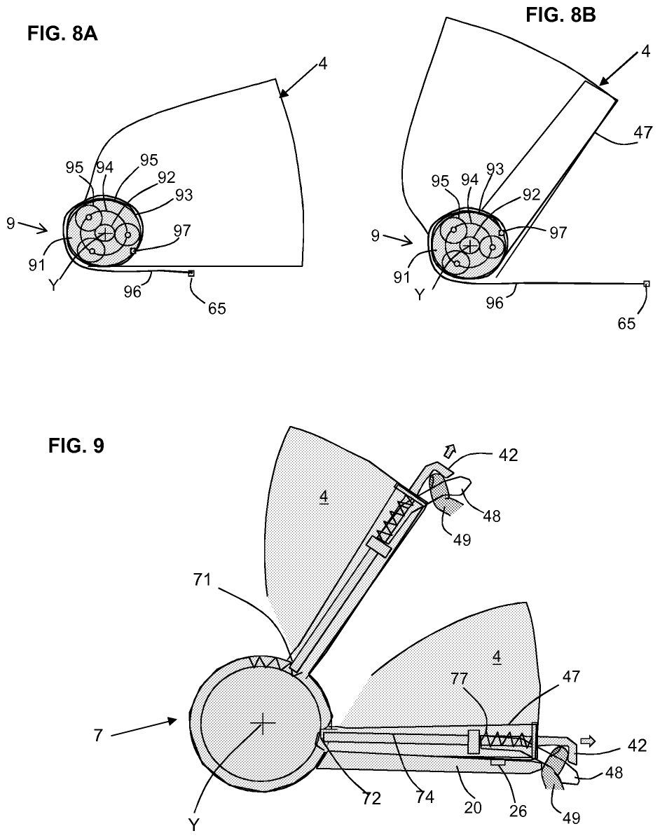

As apparent from FIGS. 1 to 9, one key feature is the airtightness at the user's neck, and a deformable membrane is provided for that.

Deformable Membrane

There is provided a deformable membrane 3 attached to the base frame 2. There may be provided a bottom junction wall 22 linking in an airtight manner the base member and the deformable membrane 3. The bottom junction wall 22 is arranged outside deformable membrane 3 and is attached in an airtight manner to the base frame 2.

The deformable membrane 3 defines a central orifice OC for the head passage and for the neck interface as discussed further below.

The deformable membrane 3 comprises an elastomeric polymer, with a large elastic extension coefficient (at least 2 even 2.5), thereby providing a ratio of large aperture versus small aperture of at least 4, in terms of area of the central orifice OC.

There is provided a deformable an aperture control device 6. The aperture control device 6 allows to change the central orifice (OC) of the deformable membrane from a large aperture state to a small aperture state in which the deformable membrane surrounds in a substantially airtight manner the neck of the user U.

The aperture control device 6 can also be called ‘iris’ or ‘diaphragm’.

More precisely, according to one illustrative example the aperture control device comprises a stationary ring 61 a movable ring 62 and extensible cords 63.

The deformable membrane is formed as a sleeve, with a first border 31 and a second border 32.

The first border 31 and the second border 32 are both attached to the stationary ring 61.

For each cord 63, a first end is attached to the stationary ring 61 and a second end is attached to the movable ring 62.

Under rotation of the movable ring 62, the cords 63 extend and pull the deformable membrane inwardly along a radial direction (toward the center, i.e. toward the user's neck when present). More precisely, each cord pushes the radial middle portion 30 of the deformable membrane toward the center.

There may be provided fours cords. However the number of cords can be any from 3 to 24. Each cord has a length comprised between 5 cm and 25 cm. The cords are made of extensible elastomeric material. They can be made of natural or synthetic rubber.

Advantageously, the external layer of the cord can be a sliding coating such the elastic extension of the cord does not pull, in the tangential direction, the radial middle portion 30 of the deformable membrane.

According to another example, the shape of the entities to which the deformable membrane is attached can be different. Any stationary member and movable member, whatever their shape, can be considered instead of rings.

When the central orifice OC of the membrane is in a large aperture state, the central orifice is large enough to let an adult human head to pass therethrough, in practice a opened cross section of at least 300 cm², preferably an opened cross section of at least 400 cm², and more preferably an opened cross section of at least 500 cm².

The smallest size of the central orifice OC of the membrane, when closed, can be as small as 100 cm², even as small as 80 cm².

Likewise, there is defined a surfacic ratio L/S (Large/Small) defined by the area of the large aperture state divided by the area of the small aperture state.

Advantageously, ratio L/S is at least 4, preferably at least 5, and preferably about 6.

According to one particular option, there is provided additionally a fabric collar 37 configurable to come into contact with the neck of the user; thus enhancing comfort. This fabric collar can be replaced, thus improving hygienic conditions. The fabric collar can be detachably coupled to a radial middle portion 30 of the deformable membrane (cf FIG. 11).

The movable ring 62 comprises a control lever 65, actuated by a cable 96. In a variant, a manual actuation is also possible for moving the movable ring 62.

Since the extensible cords 63 are resilient and provide an elastic return to the large aperture state. However, there may be provided additional biasing means to elastically return the movable ring toward a position corresponding to the large aperture state. In the illustrated example, there is provided an elastic string 67 (or tension spring) anchored at one of its end to an attachment 66 rigid with the base frame and the other end is attached to the control lever 65 or to another point rigid with the movable ring 62.

It should be noticed that both the stationary ring 61 and the movable ring 62 can be slightly deformable to become elliptic for allowing the passage of the head of the user when installing/disinstalling the respiratory equipment.

Apart from the diaphragm like the deformable membrane as discussed above, this is not excluded to use a manual zip 31 operated closure, as exemplified schematically at FIG. 2 is as another example of deformable membrane.

In the illustrated example, the left side articulation unit 8L comprises a locking system 7 and a linking mechanism 9 to drive the movable ring in dependence of the position of the visor.

Visor/Membrane Linking Mechanism

In the illustrated example, the visor/membrane linking mechanism 9 comprises a pulling cable 96 for rotating the movable ring 62.

One end of the pulling cable 96 is attached to the control level 65. The other end of the pulling cable 96 is attached to a pulley 91 arranged at the interior side of the left articulation unit 8L. The attachment point is denoted 97. The pulling cable 96 and pulley 91 work substantially as a winch. The pulley 91 is rotatably mounted on the hinge axis Y. According to one advantageous option, there is provided a multiplier gear to transform a visor rotation into a cable traction having adequate range so as to pull the movable ring about a quarter of a turn (see FIG. 4-7).

A planetary gear is provided for this purpose. According to one possible configuration, the visor hub is attached to the planet carrier 94 of the planetary gear, the sun gear 92 is fixed and the outer gear 93 is rigid with the pulley 91. This makes substantially a range/stroke doubler. Higher multiplication ratio is also possible changing the role of the planet carrier, sun gear and outer gear as known in planetary gears techniques. Planets are denoted 95.

Locking Mechanism

The locking mechanism is mainly illustrated at FIG. 9.

There is provided a control rod 74 extending from the handle 48 area to the hub area.

There is provided a push button 42, acting to pull the control rod 74 outwardly. At the visor hub, there are provided notches 72, one notch responding to the visor closed position and one or more additional notches 71 corresponding to one or more open position of the visor. There is provided a spring 77 to bias the control rod 74 towards the locking state.

The control rod can be any control member, not necessarily rod-like. The user can push forward the push button with his/her thumb 49 for example. Other variants to provide a safe operation of unlocking can also be considered.

The skilled person will appreciate that locking is obtained passively thanks to the return spring 77.

Advantageously there is provided a rebreathing circuit as depicted at FIG. 10. This is a substantially closed air circuit with a fan used to circulate the air/gas and insure its regeneration. An oxygen supply is provided with an oxygen tank compensate for the oxygen used by the user and adjust the oxygen level in the closed circuit. There is provided a carbon dioxide trapping cartridge (for example enclosing soda lime or lithium hydroxide). Further, there may be provided a gas cooling unit for reducing the air temperature within the closed volume and for causing the water vapor to condensate and to be taken out of the loop.

Inside the respiratory equipment, there are provided one or more injectors 83 for the entrance of air from the fan and vents 84 for outtake of air from the interior volume to the fan.

There may be provided several sensors (pressure, flow, CO2 . . . ), not shown, to control the system.

The air tightness performance of the proposed solution allows to have a pressure difference of 1 bar between the interior closed volume and the exterior environment of the aircraft cabin, without substantial leakage.

Regarding the tightness around the user's neck, there may be provided a third ring 69 movable related to the second double ring 62. This additional control ring allows a fine tuning of tightness by a manual control from the user.

There may be provided a sensor 26 able to detect a closed position of the rigid visor. This enables the avionic system to switch automatically audio communication to the microphone and loudspeakers provided in the respiratory equipment.

1. A respiratory equipment for an aircraft, a pilot or first officer of the aircraft forming a user of the respiratory equipment, the respiratory equipment comprising:
a shoulder support,
a base frame with a deformable membrane which comprises a central orifice with an adaptive size, configured to selectively surround in a substantially airtight manner the neck of the user, the base frame being mounted on the shoulder support,
a rigid visor movably mounted on the base frame, between a retracted position and a use position wherein the rigid visor contacts in an airtight manner the base frame,
an extendible canopy with one or more arches and a flexible wall, coupled in an airtight manner to an upper border of the rigid visor,
whereby when the rigid visor is in the closed/use position and the deformable membrane surrounds in substantially airtight manner the neck of the user, a substantially closed volume is provided, the closed volume being delimited by the deformable membrane, the base frame, the extendible canopy and the rigid visor, whereby the head of the user has no contact with the rigid visor, and no element is worn on the face.

2. The respiratory equipment according to claim 1, wherein there is provided a aperture control device to change the central orifice of the deformable membrane from a large aperture state to a small aperture state in which the deformable membrane surrounds in a substantially airtight manner the neck of the user.

3. The respiratory equipment according to claim 2, wherein there is defined a surfacic ratio L/S defined by the area of the large aperture state divided by the area of the small aperture state, where L/S is at least 4, preferably at least 5, and preferably about 6.

4. The respiratory equipment according to claim 2, wherein the aperture control device is driven in dependence with the movement of the rigid visor.

5. The respiratory equipment according to claim 4, wherein the aperture control device is driven by a cable link driven by the rigid visor.

6. The respiratory equipment according to claim 2, wherein the aperture control device comprises a manual adjustment complementary device.

7. The respiratory equipment according to claim 2, wherein the aperture control device comprises a stationary ring movable ring and extensible cords, wherein the deformable membrane is formed as a sleeve, wherein a first border and a second border of the deformable membrane being attached to the stationary ring wherein, for each extensible cord, a first end is attached to the stationary ring and a second end is attached to the movable ring.

8. The respiratory equipment according to claim 1, wherein the deformable membrane comprises an elastomeric polymer, with a large elastic extension coefficient.

9. The respiratory equipment according to claim 2, wherein the central orifice (OC) of the membrane is, in a large aperture state, large enough to let an adult human head to pass therethrough, in practice a opened cross section of at least 300 cm², preferably an opened cross section of at least 400 cm², and more preferably an opened cross section of at least 500 cm².

10. The respiratory equipment according to claim 1, further comprising a locking system for holding the rigid visor in at least one position, and a unlocking actuator/pushbutton, wherein the locking system provides locking of the rigid visor both in the retracted position and in the use position.

11. The respiratory equipment according to claim 1, wherein the upper border of the rigid visor is arcuate on both side area (left & right) providing a good side visibility.

12. The system according to claim 1, wherein the arches of the extendible canopy are arranged so they are encompassed in one another when the extendible canopy is fully retracted.

13. The respiratory equipment according to claim 1, wherein the rigid visor is rotatably mounted on the base frame with an articulation axis Y arranged at a lower auricular area with regard to the user's head position.

14. The respiratory equipment according to claim 1, wherein there are provided one or more injectors for providing fresh air with oxygen in the closed volume, said injectors are arranged in the front area of the base frame.

15. The respiratory equipment according to claim 1, further comprising a rebreathing system coupled to the closed volume through one or more gas conduits wherein a gaseous exchange in and out the closed volume is only possible through the gas conduits.

16. The respiratory equipment according to claim 1, further comprising a microphone and one or two loudspeakers.

17. The respiratory equipment according to claim 16, further comprising a position sensor configured to detect the rigid visor is in the use position, and therefore the avionics system automatically switches audio channel to the microphone and loudspeakers provided in the respiratory equipment.
